(19) United States
(12) Patent Application Publication
(10) Pub. No.: US 2005/0027578 A1
(43) Pub. Date: Feb. 3, 2005

(54) Dynamic status checklist procedure

(75) Inventors: Howell J. Chambers JR., Wake Forest, NC (US); Franklin W. Harris, Raleigh, NC (US); Thomas A. Vanderkin, Raleigh, NC (US)

Correspondence Address: DRIGGS, LUCAS BRUBAKER & HOGG CO. L.P.A., DEPT. IRA, 8522 EAST AVENUE, MENTOR, OH, 44060, US

(73) Assignee: International Business Machines Corporation, Armonk, NY (US)

(21) Appl. No.: 10/631,589

(22) Filed: Jul. 31, 2003

(51) Int. Cl. G06F 17/60

(52) U.S. Cl. 705/8

(57) ABSTRACT

A dynamic checklist system and process are provided for managing projects, wherein each project has a checklist associated with it. The checklist is developed after determining the requirements of the project. Each checklist is divided into one or more milestones, and each milestone is provided with status checks. As each step is completed, the project is allowed to continue on to the next step having a further set of one or more milestones to be completed. Further progress on the project may be interrupted until all required steps in a given checklist are completed. The process can be used to generate periodic progress reports and management status reports based on the steps completed on each checklist. The reports may be used to pinpoint actual or potential problems relating to the project, or for audit reviews, trend analyses and personnel accountability.

### BACKGROUND OF THE INVENTION

1. Field of the Invention

This invention relates to a system for the generation and use of a status checklist to enlist in the planning and performance of multiple projects or tasks using a dynamically updated, comprehensive database accessed by all participants in the projects. More particularly, the invention relates to a system monitoring and coordinating the construction of a specialized computer system.

2. Discussion of the Prior Art

Whenever a business entity or customer wants an image to be created which meets certain requirements, it is helpful to use a business process to quickly create such an image. What is meant by ‘image’ for the purpose of the present invention is a collection of all of the operating systems, applications and drivers that get loaded on a computer for the purpose of meeting the computer requirements and objectives of a given customer or other user. This ‘image’ typically includes all of the operating systems, applications and drivers. These all are bundled into a package, such as “Drive Image” marketed by Powerquest.

This image must typically meet all of the requirements of the customer, as well as many other requirements that must be met by the vendor of the image. The difficulty of meeting these requirements is multidimensional. There are endless combinations of possible steps and checks that need to be completed for each variation of a project. For example: the geographic location of key personnel essential to the project; the geographic location(s) of the customer; the testing of different applications with the requested operating system; the requirements to specific vendor manufacturing locations; the requirements for outsourced manufacturers utilized by the vendor; delivery mediums; and any interactions among them, just to name a few. There are also requirements based on whether a customer is buying directly from the vendor or through a business partner and the type of product, such as computer hardware and options that are being purchased. Also, customers are able to purchase different levels of service which affect the scope of testing that is performed for each variation of a project.

Since no one person is likely to know all the basic problems/interactions/requirements of a complex project, it is necessary to provide a procedure that makes certain that all the requirements are nonetheless checked and satisfied. For example, it is necessary to know specifically which steps are required for each variation of the project and how these steps should be grouped together. The process also needs to ensure that each group of steps for the current status (milestone) is completed before the system moves to the next status. However, personnel should be able to note if future steps have been completed early.

To make the problem worse, the requirements are not static. They may change without notice, and the process needs to be robust enough to make on-the-fly corrections to the project or to the specific process to take into consideration the new requirements and their secondary and tertiary implications.

In addition, it is required that, at any point, management is able to take a checkpoint and determine how close a set of requirements is to being satisfied, so that appropriate resources may be reallocated if necessary. Each project needs to have all the required steps grouped logically together so that all required predecessors are completed prior to advancing to the next milestone. It is also necessary for every person to easily determine what he or she is responsible to do and to update the database with his or her status as tasks are completed. Also, the project needs to be compliant with SACA, ISO and all other applicable standards.

In U.S. Pat. No. 5,826,252, a system is described for managing multiple projects of a similar type using a dynamically updated global database. The global project management database stores data for all participating projects, which is dynamically updated with best current data representing best current practices across all participating projects in the system. Localized computer terminals are operated at each local site with a common project management program and data imported from the global project management database. Periodically, the local terminals export data to the global project management database which are evaluated to determine any new best current practices across all participating projects and to update the global project management database with the new best current practices. Upon periodically importing data from the global project management database, each localized computer terminal is updated with the new best current practices across all participating projects. However, the patent does not describe a dynamic status checklist process in which every project has a checklist associated with it, and the checklist is divided into milestones and further detailed checkpoint lists. Furthermore, it does not provide for a dynamic checklist that is built to the specific requirements of a particular project based on the numerous project requirements or project types.

### SUMMARY OF THE INVENTION

An objective of the present invention is improved efficiency and reduced errors in the management of projects through the use of a computer-implemented dynamic checklist system.

This and other objectives and advantages that will become apparent upon a full and complete understanding of the following discussion of the invention are achieved as follows.

A process for the dynamic management of a project comprises multiple steps. The first step comprises determining the requirements of the project. Then a checklist is developed with at least one step and, more typically, multiple steps based on the requirements of the project. Milestones are developed relevant to each step in the checklist. These milestones are compared against the steps in the checklist to verify completion of the milestones. Further progress on the project is postponed until all required steps are completed. The process further may include the step of providing a list of details for each step in the checklist that describes the requirements for each step. As each step on the checklist is completed, the process progresses on to the next step. The process can be used to generate periodic progress reports and management status reports based on the steps completed on each checklist. The reports can be used to pinpoint actual or potential problems relating to the project, or for audit reviews, trend analyses and personnel accountability. The invention also relates to the system for performing these various steps of the process.

In addition, the invention relates to the computer implemented method for the management of a project. The method comprises receiving a paradigm of project requirements, typically prepared by a member of the project team. From this list, the computer generates a checklist of steps based on the project requirements. A list of details for each step in the checklist describes the requirements for each step. Milestones relative to each checklist which are programmed into the computer are then compared against each of the steps in the checklist to verify completion or to determine the extent to which each step is nearing completion. Until all steps are completed, the computer can block further progress on the project. The computer implemented program may also include the step of authorizing the project to move on to another step upon completion of a previous step in the checklist. Alternatively, the program can give authorization to move on without completion of the prior step.

### BRIEF DESCRIPTION OF THE DRAWINGS

FIG. 1 is a diagram of a project/checklist workflow;

FIG. 2 is a flow sheet for checklist maintenance;

FIG. 3 is a screenshot of progress checklist; and

FIG. 4 shows a computer readable medium in the form of a floppy disc.

### DETAILED DESCRIPTION OF THE INVENTION

The invention relates to an improved procedure for creating an image for use in constructing a computer to meet a customer's specific needs. The image comprises the operating systems, applications and drivers that are loaded on a computer to enable the customer or other user to have a fully functional system that will meet the objectives and needs of the user. Typical operating systems include Microsoft Windows XP Professional, Microsoft Windows NT 4.0, and Microsoft Windows 2000 Professional. Among the applications of the type contemplated by the invention are Adobe Acrobat 4.0, IBM Lotus SmartSuite and Microsoft Office XP. Audio, Video and Network Cards are among the list of drivers that are available for use in the package.

These systems, applications and drivers can then be packaged together using a tool, such as Drive Image. As a first step in the process, the requirements of a given project are determined by a project manager, computer engineer or other person having the requisite computer skills and training. A typical project for accomplishing building an image may have the following list of requirements: Hardware—IBM ThinkPad A21p 2629-HWU; Operating System—Microsoft Windows 2000 Professional; Applications—Netscape 7.1 and IBM Lotus SmartSuite 9.7; Geography of Customer—United States; Method customer is using to purchase—Directly from vendor; Level of complexity of project—Low.

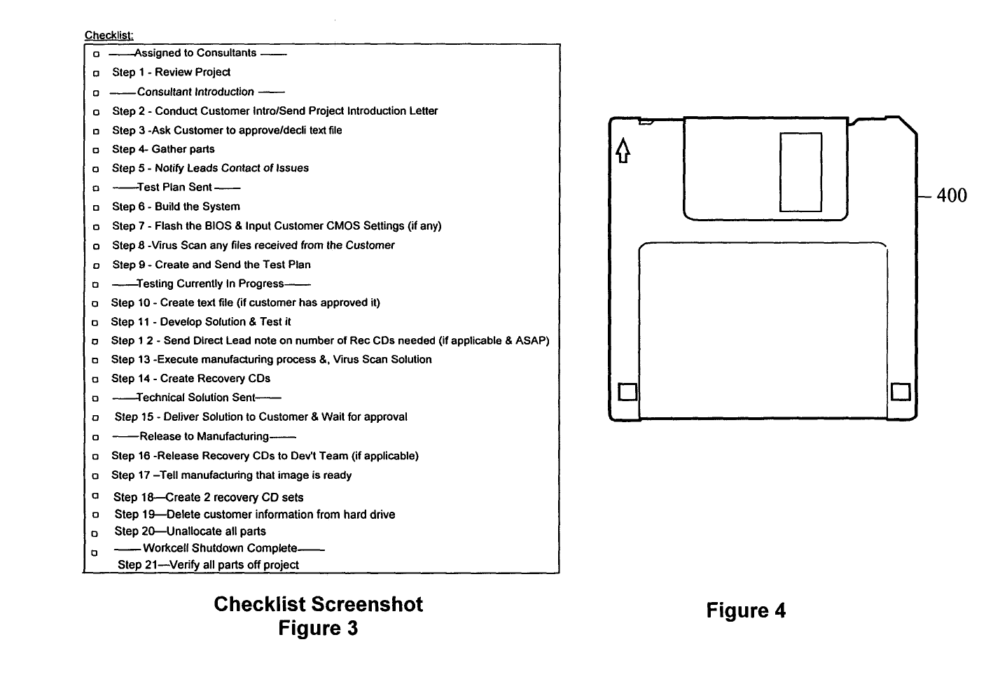

Based on the requirements that were identified in the first step, a checklist is developed. The length of this checklist will depend on the complexity of the project. For the project mentioned above, the checklist may include such items as shown in FIG. 3. Using a list of variables that have been programmed into the checklist, the computer brings all of the right steps to the checklist. Some of these variables may be hardware, operating system, applications, geography of customer, method of purchase, and level of complexity.

The computer then compares the predetermined milestones against each step in each of the checklists. These milestones typically are defined at the beginning of the project during the determination of the requirements, and thereafter become an integral part of the program. The computer then compares each step of the checklist against the milestones. If any of the checklist steps remain uncompleted causing the project to fall short of a given milestone, the computer prevents further progress of the project until all of the steps are completed.

Thus, it can be seen that, instead of doing the process the normal way (in which everyone looks at everything in the hopes that nothing will be overlooked), a systematic procedure is employed whereby every project has a checklist associated with it, and the checklist is divided into milestones. Each item in the checklist has a corresponding “details” section that delineates the requirements for the item. These checklist items are associated themselves with their implications and the person who is responsible for completing the checklist item. A database entry is automatically generated and updated with each new requirement. Whenever a checkpoint is taken, the computer collates the information and presents a list of status items completed and incomplete by any management level.

Each major milestone in the project has a status. Each status has a group of steps delineated in an electronic checklist which is electronically generated based on the possible variations, such as geographical locations, listings, delivery medium and other requirements previously mentioned. The checklist is created when the project is assigned or any time the project type for that project is changed. The user works from the checklist and electronically marks each step as that step is completed. When the user is ready to move on to the next status, the user selects the project and presses the “Add Status” button. The statuses available to users are based on their role (i.e. manager, project manager, parts crib, and engineer) and are presented to the user in a dialog box when they push the “Add Status” button. When the user selects the next status (milestone) they would like to move into, the system verifies that the user has completed the required steps for the current status before allowing them to move into that status. If all the required steps for the current status are not complete, the system prompts the user to complete the checklist and then brings up the checklist in a window.

This list of statuses and checklists are maintained in a separate control database which allows an administrator to change the flow of the database without a programmer changing the code. When an administrator updates the checklist in the system controls database, the existing checklists are automatically updated and any steps that were added or changed will be unchecked as a signal to the user that the step based on the new requirements will need to be re-verified.

All changes to the controls database are tracked to satisfy SACA and ISO requirements.

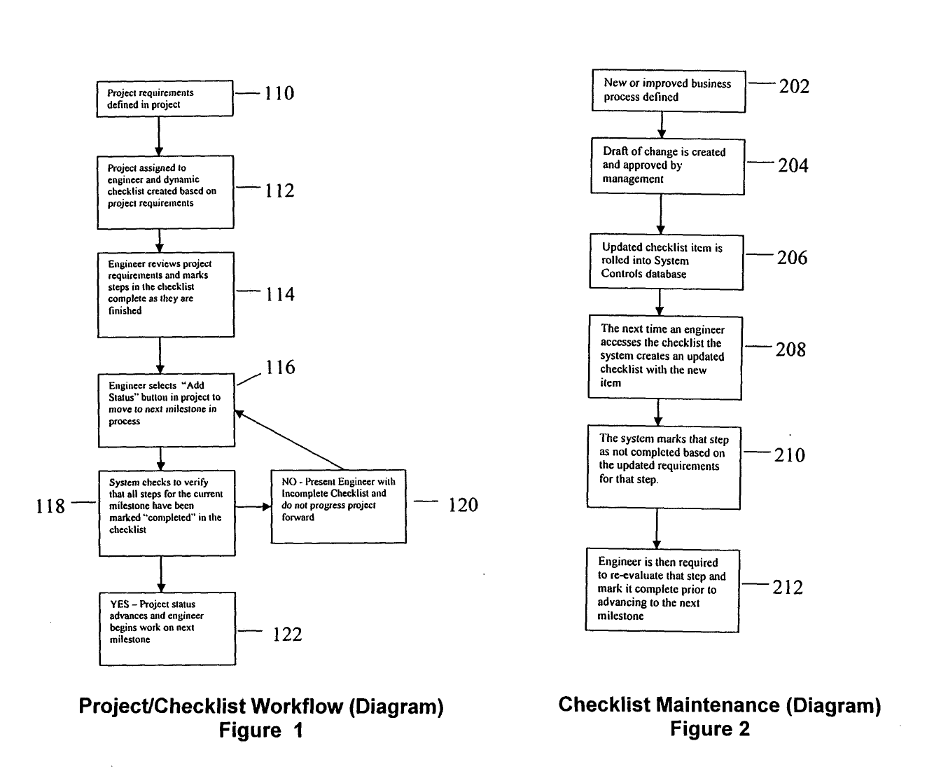

Turning now to the drawings, FIG. 1 shows a Project/Checklist Workflow according to the present invention.

Project requirements are gathered and entered in the system at 110 based on customer input. A project manager reviews the requirements of the project and determines the project type and complexity from a list of available options. Additional information that is gathered includes customer purchase method, customer geography, and billing method.

After all the required information has been entered into the system at 112, the project manager moves the project on in the workflow which is to assign the project to an engineer or other person or group of persons (e.g. project group, team or committee) responsible for its implementation. At this point, the system creates a checklist specific to the requirement for this project. The checklist includes multiple milestones that are required for that project with steps under each milestone that must be completed prior to advancing the project along to the next milestone. (See checklist screenshot in FIG. 3)

The engineer, group or team is sent a message (e.g. an e-mail) that they have been assigned a new project and the project has been added to their project queue in the system. The engineer then reviews the requirements for the project at 114 and begins to complete items in the checklist. Items in the checklist can be completed in any order; however, all the items for each milestone must be completed prior to advancing to the next milestone. Each item in the checklist has a corresponding detail section at the bottom of the checklist that explains exactly the requirements that must be done prior to marking that item on the checklist complete.

The engineer or other member of the team or group advances the project at 116 through each of the milestones in the project by pressing the “Add Status” button. When the Add Status button is pressed, the system will verify that each item has been completed at 118. If each item required for that milestone has not been completed, the system will stop the engineer from advancing and will present the engineer with the incomplete checklist at 120. At this point, the required checklist item is completed and the Add Status button is depressed to move to the next available status. If all of the steps in the current milestone are completed, the project status is advanced at 122, at which point work on the next milestone is commenced.

Management is able at any time to view the current status of the project in the database based on the milestone in each checklist. In addition, weekly measurements are exported from the database for trend analysis. When the project is complete, the checklist is stored in the system with the project for possible review later and for auditing purposes.

FIG. 2 shows the Checklist Maintenance. Business requirements change often and it is required that the checklist be able to change easily. Therefore, maintenance of the checklist is done through a separate status control database which does not require any programming skills in order to update. Administrative access to this database is limited to those who have been delegated by management with access to update the processes of the business on a worldwide basis. As business processes change or improvements to the process defined at 202 are agreed to by management, these updates are fed to an administrator to create a draft of the new process. After this draft has been approved by management at 204, it is moved into production through updating the system controls database at 206.

The next time the checklist is accessed for a project that includes the updated process, the old item in the checklist is removed and the updated process is included at 208. The new process is marked as incomplete at 210, even if the old process was marked complete. This requires all projects that included the new process to again mark this step complete according to the new process. The project cannot move on to the next milestone until this new or revised process has been updated at 212.

Each change to the checklist is logged in as a history item in a tracking database and is available for historical review and for auditing purposes.

FIG. 3 shows a typical format of a checklist 302 for use in detailing the progress of each milestone in the project. The checklist is divided into seven major milestones, wherein (a) the project is assigned to consultants, (b) the consultant is introduced to the customer and collects information relevant to the project; (c) a test plan is assembled and sent; (d) the system is tested; (e) a technical solution is sent; (f) the object of the project is released to production, and (g) the project is verified as completed.

Certain steps of project management are preferably carried out by personnel associated with a project, whereas other steps are optimally performed by computer. FIG. 4 shows a computer-readable medium in the form of a floppy disc 400 for containing the software implementation of the program to carry out the various computer-implemented steps of project management according to the present invention. Other machine readable storage mediums are fixed hard drives, optical discs, magnetic tapes, semiconductor memories, such as read-only memories (ROMs), programmable (PROMs), etc. The article containing this computer readable code is utilized by executing the code directly from the storage device, or by copying the code from one storage device to another storage device, or by transmitting the code on a network for remote execution.

There are several uses that can be made with the dynamic checklists developed in the course of a project. Among them are the generation of status reports to management. This can be provided in statistical format, or can be used as the basis to provide a narrative of activity on the project. Another use is the generation of a periodic (daily, weekly, monthly, etc.) report based on the progression toward completion of individual steps on the checklist. The checklist also provides a convenient instrument for determining accountability and aiding in performance evaluations of employees and other personnel associated with the project. The list can be used for detecting potential or actual problems in staffing, design, delivery of services or supplies, etc. associated with the project as it progresses toward its ultimate completion. The checklists are handy tools for audit reviews and trend analysis.

While the invention has been described in combination with specific embodiments thereof, there are many alternatives, modifications, and variations that are likewise deemed to be within the scope thereof. Accordingly, the invention is intended to embrace all such alternatives, modifications and variations as fall within the spirit and scope of the appended claims.

1. A process for the dynamic management of a project comprising:
a) determining the requirements of the project;
b) developing a dynamic checklist of steps based on the project requirements;
c) developing milestones relevant to each step in the checklist;
d) comparing each of the milestones against each step to verify completion of the milestones; and
e) preventing further progress of the project until all required steps are completed.

2. The process according to claim 1 further including providing a list of details for each step in the checklist that describes the requirements for each step.

3. The process according to claim 1 including the further step of progressing on to another step upon completion of the previous step in the checklist.

4. The process according to claim 1 further including generating periodic progress reports based on steps completed on each checklist.

5. The process according to claim 4 including the step of generating a management status report.

6. The process according to claim 4 further utilizing the reports for determination of actual or potential problems related to the project.

7. The process according to claim 4 including the step of using the reports for accountability of employees and other personnel.

8. The process according to claim 4 including the step of using the report for audit review and trend analysis.

9. A system for the dynamic management of a project comprising:
a) a determination of the requirements of the project;
b) a dynamic checklist of steps based on the project requirements;
c) at least one milestone relevant to each step in the checklist;
d) a comparator for comparing each of the milestones against each step to verify completion of the milestones; and
e) a procedure for preventing further progress of the project until all required steps are completed.

10. The system according to claim 9 further including a list of details for each step in the checklist that describes the requirements for each step.

11. The system according to claim 9 including a provision for progressing on to another step upon completion of the previous step in the checklist.

12. The system according to claim 9 having the further capability of generating periodic progress reports based on steps completed on each checklist.

13. The system according to claim 9 including the ability to generate a management status report.

14. The system according to claim 9 further being capable of utilizing the reports for determination of actual or potential problems related to the project.

15. The system according to claim 9 having the ability to use the reports for accountability of employees and other personnel.

16. The system according to claim 9 including ability to use the report for audit review and trend analysis.

17. A computer implemented medium containing instructions for the management of a project by a method comprising the steps of:
a) receiving a paradigm of project requirements;
b) generating a checklist of steps based on the project requirements;
c) receiving milestones relative to each checklist;
d) comparing the milestones against the steps in the checklist; and
e) either blocking further progress on the project until all steps are completed, or permitting the project to advance notwithstanding a failure to complete a step.

18. The computer implemented medium according to claim 17 further including the step of authorizing the project to move on to another step upon completion of a previous step in the checklist.
